(19) United States
(12) Patent Application Publication
(10) Pub. No.: US 2025/0167384 A1
(43) Pub. Date: May 22, 2025

(54) Battery System Frame, Housing and Method for Receiving at Least One First and at Least One Adjacent Second Battery Module in a Vehicle for Forming a Battery System

(71) Applicant: Siemens Mobility GmbH, München, Bayern (DE)

(72) Inventors: Maik Dittrich, Erlangen, Bayern (DE); Tim Weigel, München (DE); Matthias Commes, Gauting (DE)

(73) Assignee: Siemens Mobility GmbH, München, Bayern (DE)

(21) Appl. No.: 18/839,258

(22) PCT Filed: Jan. 31, 2023
(86) PCT No.: PCT/EP2023/052278

§ 371 Date: Aug. 16, 2024

(30) Foreign Application Priority Data
Feb. 25, 2022 (DE) 10 2022 201 951.2

(51) Int. Cl. H01M 50/358; H01M 10/613; H01M 10/625; H01M 10/6567; H01M 10/6569; H01M 10/658; H01M 50/224; H01M 50/333; H01M 50/342; H01M 50/383

(52) U.S. Cl. CPC H01M 50/358; H01M 10/613; H01M 10/625; H01M 10/6567; H01M 10/6569; H01M 10/658; H01M 50/224; H01M 50/333; H01M 50/3425; H01M 50/383

(57) ABSTRACT

Some embodiments of the teachings herein include a battery system. One example includes: a first battery module; and a second battery module adjacent to the first battery module. The modules are each formed of multiple battery cells arranged in separate housings made of a fire-resistant, thermally insulating material. A pressure relief arrangement acts on the housings. The housings each include a fire-resistant interface. The housings are each connected to an exhaust gas port so gases emitted are discharged using a fire-resistant exhaust air device. The housing, the interface, and/or the pressure relief arrangement at least temporarily hermetically seal the battery modules. An open support structure defines a multiplicity of air gaps formed between the first housing and adjoining surfaces thermally connected to the second housing, and the air gaps form a structure dissipating heat given off by the respective battery module with a chimney effect.

### CROSS-REFERENCE TO RELATED APPLICATIONS

This application is a U.S. National Stage Application of International Application No. PCT/EP2023/052278 filed Jan. 31, 2023, which designates the United States of America, and claims priority to DE Application No. 10 2022 201 951.2 filed Feb. 25, 2022, the contents of which are hereby incorporated by reference in their entirety.

### TECHNICAL FIELD

The present disclosure relates to batteries. Various embodiments include battery system frames for accommodating at least a first and at least one adjacent second battery module in a vehicle in order to form a battery system, housings for forming a battery system frame, and/or methods for accommodating at least a first and at least one adjacent second battery module in a vehicle in order to form a battery system.

### BACKGROUND

Battery systems based on lithium ion battery cells are used in rail vehicles for traction-related and electrical system applications. A typical lithium ion battery system for traction-related and electrical system applications, in particular for the definition of safety requirements, can be schematically illustrated as depicted in FIG. 1.

Accordingly, in the case of a battery system used for this purpose, it is possible to distinguish three levels. A first level E1 is formed by one battery cell. A number of such cells in turn forms a battery module. This can be regarded as the second level E2. The battery system and thus ultimately the third level E3 is generally formed by multiple battery modules.

Lithium ion battery cells fundamentally exhibit the risk of catching fire as a result of an internal short circuit. This reaction is strongly exothermic and is referred to as so-called thermal runaway (TRA). During such a reaction, a large amount of the electrically stored energy is converted into heat. Causes of the internal short-circuit can, for example, be faults in the production of the cells, such as foreign particles.

A TRA is—provided it was not triggered, for example, by human error—an event in a cell which generally, therefore, underlies the accident and can occur at any time, spontaneously both during operation and during storage. The causes of a TRA are set down in the cells as early as manufacture, for example. A TRA can thus not be ruled out or prevented, and therefore, in particular in the case of such large systems as are used in rail vehicles, a safety concept ensuring traffic safety is necessary.

In order to prove the safety of the battery system, the EN 62619 standard therefore requires what is referred to as the thermal propagation test (TPT). In this case, what needs to be proved is that, after an individual cell internally short-circuits, no fire occurs selectively at cell level (first level E1), module level (second level E2) or battery system level (third level E3). Known concepts ensuring this consist, for example, in producing a TRA-resistant container for the entire battery system. This solution is, however, expensive and also no longer implementable above a certain amount of energy, not least because the container is provided with a heavy outer housing.

A further approach is to use safer cells, which is to say lithium ion cells which are constructed such that they have reduced TRA energy and/or which are equipped with protective mechanisms that are internal to the cells. This approach also results in high costs.

Another concept is to provide fire-retardant barriers, for example phase-change materials, between individual cells within a module. However, this concept is not convincing in terms of the reliability of its function, whereas the approach of permanently providing an active supply of cooling water into the system by means of electrically operated water pumps in order to cool the system promises a comparatively inexpensive solution for operation of the vehicle being used, since the cooling system is already present for regular operation. A disadvantage of this, however, is that this function certainly cannot be ensured while the vehicle is shut down and the fill level of water in the cooling system is then relevant to safety.

### SUMMARY

The teachings of the present disclosure include systems and/or methods which overcome the disadvantages of the prior art, and in particular a solution which makes it possible to use lithium ion cells in vehicles, such as rail vehicles, substantially without restricting the configuration of the cells. For example, some embodiments of the teachings herein include a battery system frame for accommodating at least a first battery module (B4) and at least one adjacent second battery module (B1 . . . B3) in a vehicle in order to form a battery system, in an engine compartment of the vehicle, in particular of a rail vehicle, wherein:
a) the first battery module (B4) and the second battery module (B1 . . . B3) are formed of multiple, in particular lithium ion battery cells,
b) the first battery module (B4) and the second battery module (B1 . . . B3) are arranged in a separate housing (EG),
c) the housing (EG) is made of a fire-resistant, thermally insulating material, the thermal insulation effect in particular being enhanced by a thermal insulation (WD) mounted on the inner wall of the housing,
d) the housing (EG) comprises a pressure relief arrangement,
e) the housing (EG) comprises a fire-resistant interface for connection and operation of the battery module (B4) in the battery system (BS),
f) the housing (EG) is configured such that an exhaust gas port (AS) is connected to each pressure relief means such that gases emitted by the pressure relief means can be discharged through the exhaust gas port (AS) by means of a fire-resistant exhaust air device (AK1 . . . AK2), in particular a chimney, in a controlled way,
g) the housing (EG), the interface and/or the pressure relief means are configured and/or arranged such that the respective battery module (B1 . . . B4) is at least temporarily hermetically sealed by the housing (EG), the interface and the pressure relief means,
h) an open support structure (TS) for accommodating the first battery module (B4) and the second battery module (B1 . . . B3) is configured such that a multiplicity of air gaps (LS) is formed between the housing (EG) of the first battery module (B4) and adjoining surfaces in particular connected to the second battery modules (B1 . . . B3) by way of heat transfer, and these air gaps are connected and configured such that they form a structure which dissipates heat given off by the respective battery module (B1 . . . . B4) by virtue of a chimney effect in a controlled way.

In some embodiments, the housing (EG) is made of stainless steel.

In some embodiments, the thermal insulation (WD) is made of a bidirectionally insulating material.

In some embodiments, the pressure relief means (BM) is in the form of a rupture membrane connected to the housing (EG) and/or to the thermal insulation (WD).

In some embodiments, the pressure relief means is in the form of a rupture disk connected to the housing (EG) and/or to the thermal insulation (WD).

In some embodiments, the pressure relief means (BM) is in the form of at least one spring-loaded pressure relief flap connected to the housing (EG) and/or to the thermal insulation (WD).

In some embodiments, at least one passive cooling device (AB) is connected to at least one housing (EG) and/or to the thermal insulation (WD).

In some embodiments, the passive cooling means (AB) is configured such that the housing and/or the thermal insulation (WD) is connected to a compensating vessel (AB) filled with a cooling liquid, in particular water, and is configured such that the cooling liquid that was caused to evaporate on the housing and/or the thermal insulation owing to heat is made to run out of the compensating vessel (AB) by gravitational force and the evaporated cooling liquid is collected and cooled in the compensating vessel (AB).

Some embodiments include a housing (EG) for forming the battery system frame as described herein.

As another example, some embodiments include a method for accommodating at least a first battery module (B4) and at least one second battery module (B1 . . . B3) in a vehicle in order to form a battery system, in an engine compartment of the vehicle, in particular of a rail vehicle, characterized in that
a) the first battery module (B4) and the second battery module (B1 . . . B3) are formed of and operated on the basis of multiple, in particular lithium ion battery cells,
b) the first battery module (B4) and the second battery module (B1 . . . B3) are operated in a separate housing (EG),
c) the housing (EG) is made of a fire-resistant, thermally insulating material, the thermal insulation effect in particular being enhanced by a thermal insulation (WD) mounted on the inner wall of the housing,
d) the housing (EG) comprises a pressure relief arrangement (BM),
e) the housing (EG) comprises a fire-resistant interface for connection and operation of the respective battery module (B1 . . . Bq4) in the battery system (BS),
f) the housing (EG) is operated such that an exhaust gas port (AS) is connected to each pressure relief means (BM) such that gases emitted by the pressure relief means (BM) can be discharged through the exhaust gas ports (AS) by means of a fire-resistant exhaust air device (AK1 . . . AK2), in particular a chimney, in a controlled way,
g) the housing (EG), the interface and/or the pressure relief means (BM) are configured and/or operated in an arrangement such that the battery module (B4) is at least temporarily hermetically sealed by the housing (EG), the interface and the pressure relief means (BM),
h) an open support structure (TS) for accommodating the first battery module (B4) and the second battery module (B1 . . . B3) is configured and operated such that a multiplicity of air gaps (LS) is formed between the housing (EG) of the first battery module (B4) and adjoining surfaces in particular connected to the second battery modules (B1 . . . B3) by way of heat transfer, and these air gaps are connected and configured such that they form a structure which dissipates heat given off by the respective battery module (B1 . . . B4) by virtue of a chimney effect in a controlled way.

### BRIEF DESCRIPTION OF THE DRAWINGS

In the figures:

FIG. 1 schematically shows a definition of differentiable levels that can be applied according to the prior art in the case of a battery system;

FIG. 2 schematically shows the front view of an exemplary embodiment of an example arrangement incorporating teachings of the present disclosure; and

FIG. 3 schematically shows a side view of the exemplary embodiment of an example arrangement incorporating teachings of the present disclosure.

### DETAILED DESCRIPTION

Some embodiments of the teachings herein include a battery system frame for accommodating at least a first and at least one adjacent second battery module in a vehicle in order to form a battery system, e.g. in an engine compartment of the vehicle, in particular of a rail vehicle,
a) the first battery module and the second battery module are formed of multiple, in particular lithium ion battery cells, wherein the first battery module and the second battery module are arranged in a separate housing,
b) the housing is made of a fire-resistant, thermally insulating material, the thermal insulation effect in particular being enhanced by a thermal insulation mounted on the inner wall of the housing,
c) the housing comprises a pressure relief arrangement,
d) the housing comprises a fire-resistant interface for connection and operation of the first and the second battery module in the battery system,
e) the housing is configured such that an exhaust gas port is connected to each pressure relief means such that gases emitted by the pressure relief means can be discharged through the exhaust gas ports by means of a fire-resistant exhaust air device, in particular a chimney, in a controlled way,
f) the housing, the interface and/or the pressure relief means are configured and/or arranged such that the first and the second battery module are at least temporarily hermetically sealed by the housing, the interface and the pressure relief means,
g) an open support structure for accommodating the first and the second battery module is configured such that a multiplicity of air gaps is formed between the housing of the first battery module and adjoining surfaces in particular connected to the second battery modules by way of heat transfer, and these air gaps are connected and configured such that they form a structure which discharges heat given off by the respective battery module by virtue of a chimney effect in a controlled way.

The battery system frames described herein both provide protection against fire and its effects for the battery system containing the frame and formed therewith according to the invention and for persons located in the vehicle or, under certain circumstances, also in the immediate vicinity of the vehicle. This is brought about n in that any fire caused by a battery cell is restricted to the battery module containing this cell by the fire-resistant, which is to say high-temperature-resistant material. By suitably dimensioning and configuring this system, for example using redundancies, it is therefore additionally even possible to not adversely affect, or only insignificantly adversely affect the function of the battery system for the vehicle.

Elimination of the damage, which is to say substantially the exchange of the battery module affected, is facilitated by the teachings herein and provides protection for the maintenance worker, since these effects are provided in any operating state of the battery system or of the vehicle. This protective function is provided by, among other things, the insulation of the battery modules from one another but also the configuration of the elements of the frame, which is to say the support structure, the housing and/or the exhaust air device. The matching configurations of these elements ensures that heat and reaction gases in the system can be discharged quickly.

This may be advantageous both in normal operation and in the event of a fire, since in addition to cooling, which is provided for normal operation in any case, it can also make a contribution to maintaining the desired temperatures during normal operation, and this can, among other things, reduce abnormal cell states, and the influence on further battery modules in the event of a fire is reduced to the greatest extent. This is enhanced further by the thermal insulation inside the housing. This provides a further degree of freedom in setting the amount of heat energy introduced to the enclosed module within a certain period of time.

Another degree of freedom can be provided in particular by the selection of the properties of the housing, such that the housing is permeable to heat only in one direction, or is more permeable to heat in this direction, specifically outward. In such a configuration, the housing interacts with the thermal insulation such that the thermal insulation results in a metered discharge of heat and the adjacent housing, by virtue of this property, keeps this metered energy present in the form of already reduced heat energy away from a second module contained inside the housing for as long as possible.

In the event of a fire, the function of the pressure relief means also has an effect, since in the event of fire it is necessary to allow for an increase in pressure inside the housing, which has an effect on the structural stability of the housing and can destroy it. Such suitable dimensioning of the pressure relief means ensures according to the invention that on or before reaching a destructive pressure, the gas responsible for the pressure can escape.

In conjunction with the exhaust air device, to which this gas is fed via the exhaust gas ports, the gas can escape in a controlled way, such that other elements of the battery system are also not destructively affected. The exhaust gas ports ensure in this case that the exhaust air device of the adjacent modules can provide this function harmlessly and thus also after such an incident. To this end, the device and the exhaust gas ports are also fire-resistant similarly to all the other elements that are or can be connected outside the housing.

In some embodiments, battery modules can in principle be formed by all types of battery cells in the case of which a fire or other destructive events that are transferred to neighboring modules cannot be completely ruled out. The battery system is homogeneous, which is to say completely fitted with such battery modules, and thus all the battery modules can be accommodated, encapsulated in a housing, in the support structure for forming the battery system frame.

This thus makes it possible to use unsafe battery modules, which are for example at least to some extent formed by lithium ion cells, and to integrate them in a battery system of a vehicle. This makes it possible to use battery cells which are inexpensive and/or have a higher energy density.

The housings described herein are distinguished in that they may be configured in such a way that it provides the stated function as per battery support systems and/or as per one of the refinements of this function that are specified in the dependent claims, or for these functions and the combinations thereof. As a result, the housing performs well in terms of the formation of the battery system frame and of the implementation of the advantages of the methods described herein.

In the case of the methods described herein for accommodating at least a first and at least one adjacent second battery module in a vehicle in order to form a battery system, e.g., in an engine compartment of the vehicle, in particular of a rail vehicle,
a) the first battery module and the second battery module are formed of and operated on the basis of multiple, in particular lithium ion battery cells,
b) the first and the second battery module are operated in a separate housing,
c) the housing is made of a fire-resistant, thermally insulating material, the thermal insulation effect in particular being enhanced by a thermal insulation (WD) mounted on the inner wall of the housing,
d) the housing comprises a pressure relief arrangement,
e) the housing comprises a fire-resistant interface for connection and operation of the respective battery module in the battery system,
f) the housing is operated such that an exhaust gas port is connected to each pressure relief means such that gases emitted by the pressure relief means can be discharged through the exhaust gas ports by means of a fire-resistant exhaust air device, in particular a chimney, in a controlled way,
g) the housing, the interface and/or the pressure relief means are configured and/or operated in an arrangement such that the battery module is at least temporarily hermetically sealed by the housing, the interface and the pressure relief means,
h) an open support structure for accommodating the first and the second battery module is configured and operated such that a multiplicity of air gaps is formed between the housing of the first battery module and adjoining surfaces in particular connected to the second battery modules by way of heat transfer, and these air gaps are connected and configured such that they form a structure which discharges heat given off by the respective battery module by virtue of a chimney effect in a controlled way.

The methods described herein may make it possible to provide and operate the battery system frame and thus also has the advantages of said battery system and the advantages of any of its refinements.

In some embodiments, the housing, in particular as many of the elements of the battery system frame as possible, is made of stainless steel which is in particular provided with a suitable insulating material, and is operated such that a housing provides a very good combination of fire resistance, stability and thermal insulation. Moreover, stainless steel does not need rust-resistant coating and lacquering, which are often necessary in the case of other materials. These are potentially combustible. This configuration therefore also reduces the fire loading.

In some embodiments, the battery system frame can be configured and operated such that the thermal insulation is made of a bidirectionally insulating material. This makes it possible to meter the discharge of heat in both directions. As a result, additional degrees of freedom in the optimization of the protection are provided.

The battery system frames can also, alternatively or additionally, be refined and operated such that the pressure relief means is in the form of and operated as a rupture membrane connected to the housing and/or to the thermal insulation. This gives a simple and inexpensive implementation of the pressure relief means, which ruptures in the direction of the exhaust gas device above a determined pressure owing to exhaust combustion gases and/or after a determined temperature is reached and can thus allow the discharge of exhaust gases and/or heat. This membrane can then be part of the housing and/or of the thermal insulation.

In some embodiments, the battery system frame is configured and operated such that the pressure relief means is in the form of a rupture disk connected to the housing and/or to the thermal insulation. Such rupture disks are standardized and generally contain a rupture membrane with the aforementioned advantages, such that an accommodation option, in accordance with the standard, can be mounted in the housing or the thermal insulation. Such standardized parts are generally obtained in relatively large numbers and therefore, in addition to the aforementioned advantage, have the advantage that they are inexpensive to acquire.

In some embodiments, the battery system frame can be refined such that the pressure relief means is in the form of and operated as at least one spring-loaded pressure relief flap connected to the housing and/or to the thermal insulation. Such a pressure relief flap may only allow gases through above a certain pressure. A spring-loaded pressure flap has the advantage that it only allows solids smaller than the diameter of the flap opening through. By contrast to the rupture membrane or the rupture disk, therefore, only the very smallest solid particles, which are generally easier to remove, enter the exhaust air device. The pressure relief flap itself is also not subject to destruction and closes again after the excess pressure has been discharged, with the result that the oxygen supply into the module is then interrupted. This thus additionally increases the fire protection.

Rupture membranes and/or spring-loaded pressure relief flaps preferably have an opening dimensioned such that clogging by solid particles can be ruled out, or the likelihood of this happening is virtually 0. In addition, the battery system frame can be refined in such a way that at least one passive cooling device is connected to at least one housing and/or to the thermal insulation. This enhances the passive cooling already provided by the air gaps in the frame structure and can provide a cooling function beyond in particular the protection demanded by the standard or TPT.

This further passive cooling may then refined and operated in such a way that the housing and/or the thermal insulation is connected to a compensating vessel filled with a cooling liquid, in particular water, and is configured such that the cooling liquid that was caused to evaporate on the housing and/or the thermal insulation owing to heat is made to run out of the compensating vessel by gravitational force and the evaporated cooling liquid is collected and cooled in the compensating vessel. This provides a closed circuit which ensures cooling independently of the chimney effect.

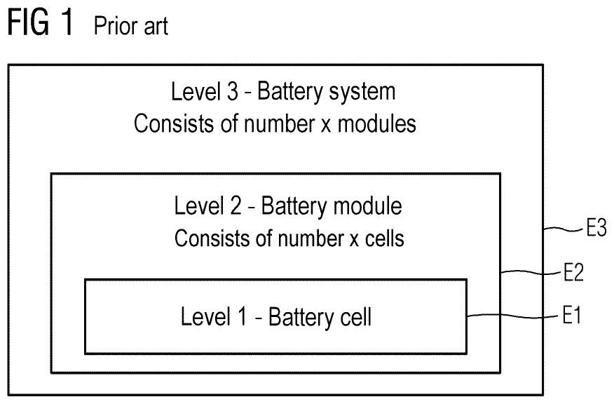

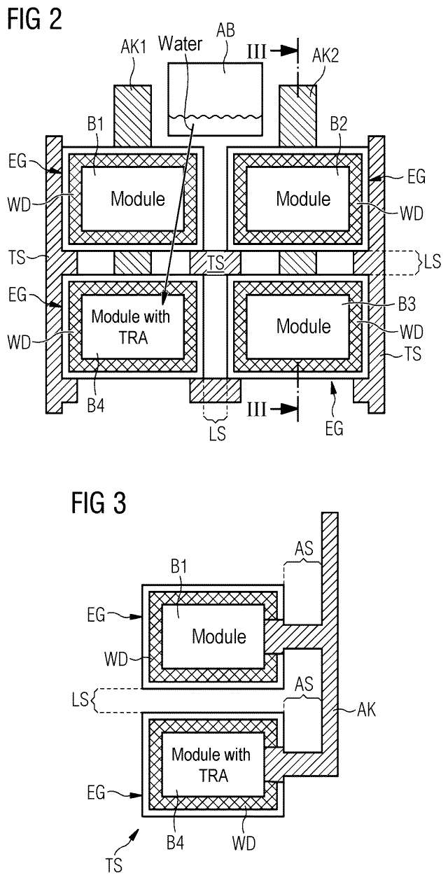

Further advantages and details of various embodiments of the teachings herein are explained on the basis of the prior art illustrated in FIG. 1 with reference to the views of example embodiments are illustrated in FIGS. 2 to 3.

In the views of the exemplary embodiments, the described components of the embodiment each constitute individual features that are to be regarded as independent of one another and each also refine the teachings independently of one another, and thus also can be considered to be constituent parts of the disclosure on their own or in a different combination to that shown. Furthermore, the described components of the embodiment illustrated can also be supplemented by other already-described features. Any specifications regarding functions and mode of operation can moreover also be regarded as a procedure according to an exemplary embodiment, even if this is not explicitly mentioned. Identical reference signs have the same meaning in the various figures.

FIG. 1 illustrates, as already described, the subdivision of a typical lithium ion battery system for traction-related and electrical system applications. This subdivision serves as a basis for the determination of functional units. They are placed in a relationship for, among other things, the definition of safety requirements according to the EN 62619 standard.

What is shown is the first level E1, which denotes a first functional unit formed by a battery cell. What is also shown is the second level E2, which denotes a second functional unit that is formed by one or more battery modules and is generally formed of a plurality of cells, which is to say first functional units. What is lastly shown is also the third level E3, which denotes the third functional unit that is formed by a battery system and is formed of at least one battery module.

The safety requirement according to the EN 62619 standard, what is referred to as the thermal propagation test (TPT), is met when it can be proved that the system is configured such that, in the event of a TRA, fires can be ruled out either at cell level E1, module level E2 or at battery system level E3.

The embodiments of the teachings herein shown in FIG. 2 and

FIG. 3 in a front and side view of an exemplary embodiment, to this end proposes a concept for implementing the TRA protection at module level E2, which in terms of fire protection leads to level E3 and thus realizes the second alternative according to the standard. FIG. 2 illustrates the front view in the form of an exemplary embodiment of an arrangement incorporating teachings of the present disclosure, which is taken t as a basis to also as exemplary embodiment schematically illustrate a method incorporating teachings of the present disclosure and explain the procedure.

What is shown is an accommodating support structure TS. According to the embodiment shown, this support structure TS is shaped in the form of an open frame which is also configured such that it is configured—as FIG. 2 shows—to accommodate multiple battery modules B1 . . . B4 and this configuration is provided such that, with accommodated battery modules B1 . . . B4, air gaps LS are formed at least between the battery modules B1 . . . B4. The frame in this case according to the example is in the form of a rivet-screw structure. This allows individual components to be exchanged after assembly or mounting in an engine compartment.

In this respect, the teachings are not restricted solely to a formation of the support structure TS for the formation of the air gaps. Rather, the battery modules B1 . . . B4, which is to say for example a housing EG, which accommodates the cells forming the battery module, of the battery module, can be formed such that these air gaps LS are formed after being mounted in a support structure TS—conjointly with the support structure TS or alternatively thereto. The function of the air gaps LS, which is to say a method step according to an exemplary embodiment of the method, is to ensure heat dissipation on the basis of convective cooling.

To this end, according to one exemplary embodiment of the arrangement incorporating teachings of the present disclosure the support structure TS is and/or the battery modules, in particular a housing EG which accommodates the cells of the battery module B1 . . . B4, are configured such that the air gaps LS formed align to produce a chimney effect, which can quickly dissipate heat discharged in the air gaps LS in a controlled way. This alignment leads to this chimney effect, at least with parts of the battery system or frame. These slots LS can also extend to an exhaust gas chimney (chimney) AK, with the result that the latter also participates in the chimney effect as a result of the air gap LS and can contribute to the cooling of the structure, in addition to its function of dissipating exhaust gas. Then, as a consequence according to a further step according to an exemplary embodiment of the method, exhaust gases from one of the battery modules B1 . . . B4 that are produced in the event of a fire are carried in the form of hot gases to at least one chimney AK1 . . . AK2, which ensures discharge of these exhaust gases, with the result that the chimney effect ensures quick dissipation of heat/exhaust gas, or cooling, and the other battery modules B1 . . . B4 can be protected by the separate chimney AK1 . . . AK2.

In the exemplary embodiment illustrated, two chimneys AK1 . . . AK2 are mounted. The number of chimneys AK1 . . . . K2 is not limited to this, however. Rather, there can be any desired number of chimneys AK or the individual chimneys AK can be collected into a common chimney for the entire system. This can depend on the desired effect or degree of optimization and/or preset parameters such as degrees of freedom in the dimensioning of the arrangement.

Since in the exemplary embodiment illustrated the battery modules B1 . . . B4 are arranged in two rows and two columns, a respective column has been allocated to the two chimneys AK1 . . . AK2. As a departure from this, therefore, a solution dependent on the number of columns would also be conceivable. Thus, for example, one chimney for the two columns or even three or even more chimneys. This can depend on where the center of gravity is in the configuration of the arrangement. In the example shown, one advantage is that cooling which is uniform for all columns can be assumed or striven for.

As FIG. 2 also shows, a first battery module B1, a second battery module B2 and a third battery module B3 are not subject to a TRA event. Only in the case of the fourth battery module B4 is a TRA event regarded as taking place spontaneously for the explanation of the exemplary embodiments. This event threatens a fire owing to the TRA. This fourth battery module B4 is thus also for example fitted with at least one lithium ion cell which is regarded as unsafe; for example, because it has a high energy density and/or does not have any particular safety measures internal to the cell that prevent and/or minimize the likelihood of short circuits and thus TRA events.

According to the exemplary embodiment of the figures, all the modules are fitted with battery modules B1 . . . B4 which are “unsafe” in terms of the likelihood of a TRA.

In some embodiments, there is a compensating vessel AB. This compensating vessel AB is filled with water and connected to the one unsafe fourth battery module B4 according to the exemplary embodiment, such that its water is made to run to the fourth battery module B4 by gravitational force.

The fourth battery module B4 is, as is also the case for the other battery modules B1 . . . B3, configured such that it heats this water, by way of its heating up, until it evaporates and the water can run from the compensating vessel AB to the extent of the volume of the evaporated water.

This refinement assists the arrangements for further improving cooling by means of enthalpy of evaporation, which is not imperatively necessary, in particular not in terms of the existence of the TPT, since the exemplary embodiments in principle already meet the safety requirements without such a compensating vessel AB. Rather, this refinement constitutes a further passive cooling option which can offer further safety. That is to say, it constitutes a buffer to some extent.

In some embodiments, if this refinement is used, each unsafe battery module B1 . . . B3 is connected to such a compensating vessel AB and correspondingly configured to be able to carry out this additional method step of cooling. The amount of unsafe battery modules B1 . . . B3 connected to the compensating vessel AB can be selected freely according to the respective requirements for the system that is to be placed in a vehicle.

FIG. 2 also shows that the battery modules B1 . . . B4 are formed such that they are surrounded by a thermal insulation WD. In some embodiments, this thermal insulation WD is configured such that it has a bidirectional action. The thermal insulation is also installed virtually all around the respective module B1 . . . B4. In general, only the interfaces, or openings for this or other openings that absolutely must be present are free thereof. The battery modules B1 . . . B4 are additionally supplemented by a rupture membrane which is not visible in this view. Necessary interfaces of the battery modules B1 . . . B4 are also fire-resistant.

The thermal insulation WD and the rupture membrane BM are in turn encapsulated by the housing EG except for necessary cutouts, and the housing is shaped or formed with respect to the aforementioned configurations in such a way that it is accommodated in the support structure TS and/or forms or supplements part of the support function of the support structure.

As is now shown in the side view illustrated in FIG. 3 of the exemplary embodiment of the arrangement, the stainless steel housing EG of the modules B1 . . . B4 is in each case formed such that the rupture membrane BM is caused to lie on an exhaust gas port AS, with the result that the respective battery module B1 . . . B4 is in each case connected to the exhaust gas chimney AK via the exhaust gas port AS. The rupture membrane BM can be in the form of a rupture disk containing a rupturing membrane. It is also conceivable that the membrane, similarly to the structure of a rupture disk, with the thermal insulation WD, which is located on the side of the exhaust gas ports AS.

The rupture membrane BM—with or without implemented rupture disks—ensures protection of the rest of the battery modules B1 . . . B4, or the entire support structure TS, in the event of an excess pressure occurring in the respective battery module B1 . . . B4 which is encapsulated in the thermal insulation WD and the stainless steel housing EG and in which the excess pressure can make the membrane BM burst when a critical level is reached and the pressure can thus escape via the exhaust gas chimneys AK as a controlled feed through the exhaust gas ports AS.

In some embodiments, in the event of a TRA, the damage remains limited to the affected individual battery module B1 . . . B4. This means that, in principle, one exhaust gas port AS per unsafe battery module BM would be fundamentally sufficient for this purpose. The exemplary embodiment illustrated thus also goes beyond necessary protection and the effect of the invention in this respect, since it also adjoins safe modules B1 . . . B3, and constitutes one of the possible refinements that are possible according to the invention for providing additional safety.

Among other things, the air gaps LS and also the stainless steel housing EG and the bidirectional thermal insulation WD also contribute to this aim. Specifically, the housing EG contributes in that it is stable but also thermally conductive, and the thermal insulation WD contributes since it both protects the respective battery module B1 . . . B4 from externally penetrating heat and also restricts discharge of the heat in normal operation but also and primarily in the event of a TRA to the extent that this alone, and/or in interaction with the other features according to the invention of the arrangement or of the method, is enough to not disrupt the functionality of the safe battery modules B1 . . . B3.

This makes it possible to use lithium cells with a very high energy density in vehicles, in particular rail vehicles. The TRA is restricted to a TRA-affected, which is to say generally unsafe battery module B3. Accordingly, to some extent this defines the smallest combustible unit which fails in a battery module B3. The safe, or remaining modules B1 . . . B3 not affected by TRA are still fully functional.

The concept is intended specially for lithium ion cells, which have no TRA protection at cell level. However, it is not restricted thereto. Fundamentally, the invention provides a reduction in damage caused by destructive energies from a fire in any kind of module B1 . . . B4. However, it is its protective concept that affords the most advantages specifically if unsafe cells are being used.

It becomes possible that only the module affected needs to be changed after a fire event. Depending on the control and interconnection of the modules B1 . . . B4, or in a manner assisted by redundancies, in such a case the operation of the battery system BS can be continued virtually uninterrupted, even in the event of a fire. Since the arrangements and the methods described herein make an active cooling circuit obsolete and intended cooling methods are purely passive solutions, the protection in operating states is provided, in particular even when the vehicle is not running or when the vehicle is turned off.

The teachings herein therefore make it possible, for protection which is sufficient according to TPT, to disengage from a safety mechanism at cell level that is necessary in the first level E1. It is possible to use essentially lower priced lithium ion cells. These are available in considerably greater numbers than safer lithium ion cells are and thus reduce the cell costs of the battery system incorporating the teachings herein.

The solutions described herein also require substantially no concept realized in the third level E3, which is also implementable only with great difficulty, since the TRA energy being released from the overall burning battery system with a high number of cells makes any protective measures technically unimplementable and uneconomical. The teachings thus overcome the disadvantage that the container that provides resistance at the onset of a TRA is for the entire battery system BS. In that case, there is loss of the overall system specifically in the event of a fire owing to a TRA in one cell of a single module. A saving is also made on a heavy outer housing which needs to be dimensioned for large amounts of energy, this driving up costs.

The teachings additionally reduce the likelihood of outages. There is even a design buffer for future cell generations that have an even higher energy density. More than enough protection is therefore provided for present systems. The outlay necessary for this is run out in an acceptable use of additional material and/or extra weight for the TRA protection, since the housing EG also at the same time forms parts of the frame TS.

The teachings are not restricted to the exemplary embodiments shown and discussed of the arrangement and of the method and their refinements. Rather, the scope as defined by the claims is intended to include all the variants—even those that are not claimed—that are covered by the claims.

What is claimed is:

1. A battery system the system comprising:
a first battery module; and
a second battery module adjacent to the first battery module;
wherein the first battery module and the second battery module are each formed of multiple battery cells arranged in two separate housings comprising a fire-resistant, thermally insulating material;
a pressure relief arrangement acting on the two housings;
the two housings each include a fire-resistant interface for connection and operation of the respective battery module;
the two housings are each configured such that an exhaust gas port is connected to each pressure relief arrangement such that gases emitted by the pressure relief arrangement can be discharged through the exhaust gas port using a fire-resistant exhaust air device;
the respective housing, the interface, and/or the pressure relief arrangement are configured so the respective battery module is at least temporarily hermetically sealed;
an open support structure for accommodating the first battery module and the second battery module configured with a multiplicity of air gaps formed between the housing of the first battery module and adjoining surfaces thermally connected to the second battery modules, and the multiplicity of air gaps are connected and configured to form a structure dissipating heat given off by the respective battery module with a chimney effect.

2. The battery system as claimed in claim 1, wherein the two housings comprise stainless steel.

3. The battery system frame as claimed in claim 1, wherein the thermal insulation comprises a bidirectionally insulating material.

4. The battery system frame as claimed in claim 1, wherein the pressure relief means comprises a rupture membrane connected to the perspective housing and/or to the thermal insulation.

5. The battery system frame as claimed in claim 1, wherein the pressure relief arrangement comprises a rupture disk connected to the respective housing 1 and/or to the thermal insulation.

6. The battery system frame as claimed in claim 1, wherein the pressure relief arrangement comprises a spring-loaded pressure relief flap connected to the respective housing and/or to the thermal insulation.

7. The battery system frame as claimed in claim 1, further comprising a passive cooling device connected to at least one housing and/or to the thermal insulation.

8. The battery system frame as claimed in claim 7, wherein the passive cooling device is configured so the respective housing and/or the thermal insulation is connected to a compensating vessel filled with a cooling liquid, and is configured so the cooling liquid caused to evaporate on the housing and/or the thermal insulation owing to heat runs out of the compensating vessel by gravitational force and the evaporated cooling liquid is collected and cooled in the compensating vessel.

9. (canceled)

10. A method for forming a battery system the method comprising:
defining a first battery module and a second battery module each formed of multiple battery cells;
disposing the first battery module and the second battery module in respective separate housings;
wherein each of the housings comprises a fire-resistant, thermally insulating material,
a respective pressure relief arrangement, and
a respective fire-resistant interface for connection and operation of the respective battery module;
wherein each pressure relief arrangement is connected to a respective exhaust gas port so gases emitted by the pressure relief arrangement are discharged through the exhaust gas ports by a fire-resistant exhaust air device;
wherein the respective housing, the interface, and/or the pressure relief arrangement are configured so the battery module is at least temporarily hermetically sealed; and
wherein an open support structure accommodating the first battery module and the second battery module is configured so a multiplicity of air gaps is formed between the housing of the first battery module and adjoining surfaces thermally connected to the second battery modules, and the multiplicity of air gaps are connected to form a structure dissipating heat given off by the respective battery module using a chimney effect.
